(19) United States
(12) Patent Application Publication
(10) Pub. No.: US 2008/0248258 A1
(43) Pub. Date: Oct. 9, 2008

(54) MOUNTING SUPPORT FOR RETAINING A FLEXIBLE PRINTED CIRCUIT BOARD

(75) Inventor: JIAN-YI HAO, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: FUKUI PRECISION COMPONENT (SHENZHEN) CO., LTD., Shenzhen City (CN); FOXCONN ADVANCED TECHNOLOGY INC., Tayuan (TW)

(21) Appl. No.: 11/947,071

(22) Filed: Nov. 29, 2007

(30) Foreign Application Priority Data
Apr. 6, 2007 (CN) 200710073981.2

(51) Int. Cl. B32B 3/00

(52) U.S. Cl. 428/172

(57) ABSTRACT

An exemplary mounting support for retaining a flexible printed circuit board is provided. The flexible printed circuit board has a first portion and a second portion. A thickness of the first portion is greater than that of the second portion. The mounting support includes a supporting platform and an adhesive layer disposed on the supporting platform. The adhesive layer includes a first adhesive portion mating with the first portion, and a second adhesive portion mating with the second portion. A thickness of the first adhesive portion is less than that of the second adhesive portion. A thickness difference between the first adhesive portion and the second adhesive portion is equal to a thickness difference between the first portion and the second portion.

### BACKGROUND

1. Technical Field

The present invention relates to a mounting support for retaining a flexible printed circuit board.

2. Description of Related Art

Surface mounting technology (SMT) is a method for constructing electronic products in which electronic components are mounted directly onto a surface of a printed circuit board. Surface mounting technology includes processes of solder paste printing, component placement, reflow and wave soldering, and so on. Nowadays, surface mounting technology has gradually replaced the previous construction method of fitting electronic components with wire leads into holes in the circuit board (also called through-hole technology).

Nowadays, electronic products have achieved miniaturization in volume and diversification in function. Flexible printed circuit boards are widely used because of their flexibility and lightness. For the convenience of surface mounting, it is necessary for the flexible printed circuit board to be held in a typical supporting manner (e.g., a plate with adhesive tapes at corners). However, usually the whole flexible printed circuit board cannot be stably fixed in the typical mounting manner. Thus, quality of surface mounting can be affected to some extent. Additionally, structures of flexible printed circuit boards used in the electronic products are complicated (e.g., flexible printed circuit boards with stepped structure). Similarly, the typical mounting manner is not suitable for retaining flexible printed circuit boards with complicated structure.

What is needed, therefore, is a mounting support that is capable of retaining a complicated flexible printed circuit board to surface mount.

### SUMMARY

One present embodiment provides a mounting support for retaining a flexible printed circuit board. The flexible printed circuit board has a first portion and a second portion. A thickness of the first portion is greater than that of the second portion. The mounting support includes a supporting platform and an adhesive layer disposed on the supporting platform. The adhesive layer includes a first adhesive portion for mating with the first portion of the flexible printed circuit board, and a second adhesive portion for mating with the second portion of the flexible printed circuit board. A thickness of the first adhesive portion is less than that of the second adhesive portion. A thickness difference between the first adhesive portion and the second adhesive portion is equal to a thickness difference between the first portion and the second portion.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of a flexible printed circuit board;

FIG. 2 is a schematic view of a mounting support for retaining the flexible printed circuit board according to an exemplary present embodiment; and

FIG. 3 is a schematic view of the mounting support of FIG. 2 retaining the flexible printed circuit board thereon.

### DETAILED DESCRIPTION OF THE EMBODIMENTS

Embodiments will now be described in detail below and with reference to the drawings.

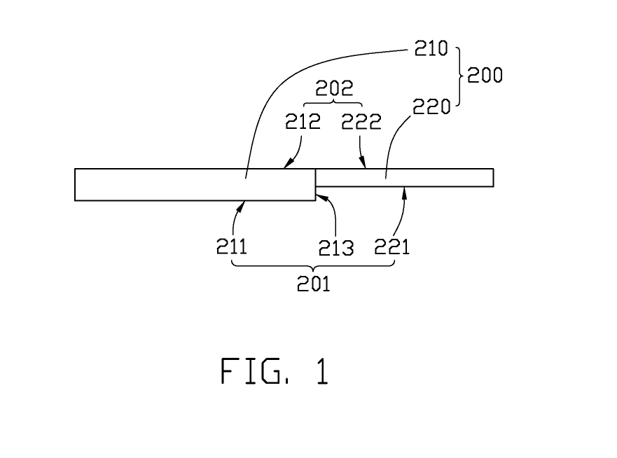

In FIG. 1, a flexible printed circuit board 200 is shown. The flexible printed circuit board 200 is configured for mounting electronic components using surface mounting technology.

For purpose of illustration only, the flexible circuit board 200 has a stepped structure in the present embodiment. The flexible printed circuit board 200 includes a first portion 210 and a second portion 220. In this embodiment, the second portion 220 is connected and extended from the first portion 210. A thickness of the first portion 210 is greater than that of the second portion 220. The first portion 210 and the second portion 220 can be a single-layer structure or a multilayer structure containing, for example, two layers, four layers, six layers or more. In a word, the thickness of the first circuit board 210 and that of the second circuit board 220 are different. In other embodiments, the flexible circuit board 200 may have three or more portions with different thicknesses. In the present embodiment, the first portion 210 is a multilayer structure containing six layers and the second portion 220 is a multilayer structure containing two layers.

The first portion 210 has a first surface 211 and a second surface 212 on an opposite side of the first portion 210 to the first surface 211. The second portion 220 has a third surface 221 and a fourth surface 222 on an opposite side of the second portion 220 to the third surface 221. The thickness of the first portion 210 is greater than that of the second portion 220. Thus, the first surface 211 and the third surface 221 are not coplanar, and the second surface 212 and the fourth surface 222 are coplanar. The thicker first portion 210 connects to the thinner second portion 220, thereby forming a side surface 213 at the junction therebetween. The first surface 211, the side surface 213 and the third surface 221 are located on one side of the flexible printed circuit board 200 and define a first contacting surface 201. The first contacting surface 201 is configured for contacting with a mounting support. The second surface 212 and the fourth surface 222 are located on the other side of the flexible printed circuit board 200 and define a mounting surface 202. The mounting surface 202 is configured for mounting electronic components thereon. It is understood that the second surface 212 and the fourth surface 222 may also be noncoplanar.

It is understood that the flexible circuit board configured for mounting electronic components may have other structures. For example, the flexible circuit board may be a double surface mounted flexible printed circuit board. The flexible circuit board defines a number of mounting grooves in both sides thereof, and thus the flexible circuit board also has portions with different thickness.

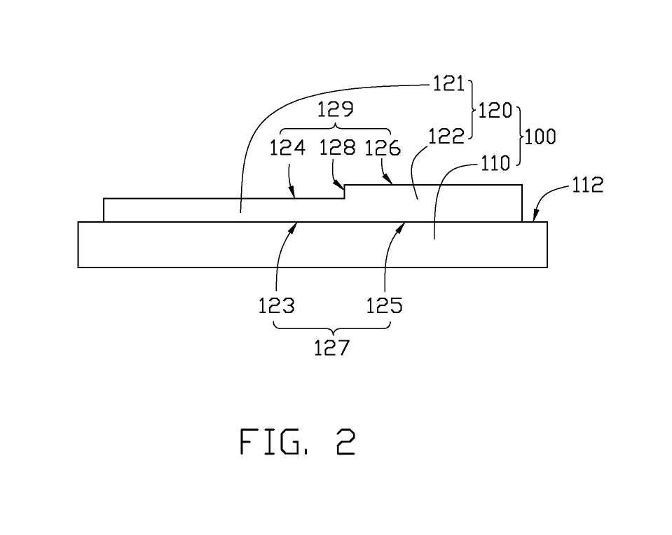

Referring to FIG. 2, a mounting support 100 for retaining the flexible printed circuit board 200 is shown. In the present exemplary embodiment, the mounting support 100 can be designed to come into contact with the contacting surface 201 of the flexible printed circuit board 200.

The mounting support 100 includes a supporting platform 110 and an adhesive layer 120 disposed on the supporting platform 110.

The supporting platform 110 can be made of a metal material, such as copper, aluminum, iron and an alloy of copper, aluminum and iron, or a polymer material such as polytetrafluoroethylene (PTFE), etc. In this embodiment, the supporting platform 110 is an aluminum board with a flat surface, i.e., a supporting surface 112.

The adhesive layer 120 includes a number of adhesive portions with different thickness. In the present embodiment, the adhesive layer 120 is a stepped structure, which includes a first adhesive portion 121 and a second adhesive portion 122. A thickness of the first adhesive portion 121 is less than that of the second adhesive portion 122. Preferably, the adhesive layer 120 can be made of silica.

The first adhesive portion 121 has a first adhesive surface 123 and a second adhesive surface 124 on an opposite side of the first adhesive portion 121 to the first adhesive surface 123. The second adhesive portion 122 has a third adhesive surface 125 and a fourth adhesive surface 126 on an opposite side of the second adhesive portion 122 to the third adhesive surface 125. The thickness of the first adhesive portion 121 is less than that of the second adhesive portion 122, thus the second adhesive surface 124 and the fourth adhesive surface 126 is not coplanar, and the first adhesive surface 123 and the third adhesive surface 125 is coplanar. The thinner first adhesive portion 121 is jointed with the thicker second adhesive portion 122, thereby forming an adhesive side surface 128 at the junction therebetween.

The second adhesive surface 124, the adhesive side surface 128 and the fourth adhesive surface 126 are located on one side of the adhesive layer 120 and define an adhering surface 129. The adhering surface 129 is configured for contacting with and adhering to the flexible printed circuit board 200. A configuration of the adhering surface 129 is conformed to that of the first contacting surface 201 of the flexible printed circuit board 200. The first adhesive surface 123 and the third adhesive surface 125 are located on the other side of the adhesive layer 120 and define a second contacting surface 127. The second contacting surface 127 is configured for contacting with and adhering to the supporting platform 110. A configuration of the second contacting surface 127 is conformed to that of the supporting surface 112 of the supporting platform 110. It is understood that the first adhesive surface 123 and the third adhesive surface 125 can also be noncoplanar when the supporting surface 112 is not flat.

The adhesive portions with different thickness of the adhesive layer 120 are mated with portions with different thickness of the flexible printed circuit board 200. In the present embodiment, the adhesive layer 120 is a stepped structure corresponding to the stepped structure of the flexible printed circuit board 200. In detail, the first adhesive portion 121 corresponds to the first portion 210, and the second adhesive portion 122 corresponds to the second portion 220. The thickness difference between the first adhesive portion 121 and the second adhesive portion 122 is equal to the thickness difference between the first portion 210 and the second portion 220 such that the adhering surface 129 of the adhesive layer 120 is mating with the first contacting surface 201 of the flexible printed circuit board 200. Thus, the flexible printed circuit board 200 can be stably fixed on the mounting support 100 with the adhesive layer 120.

The adhesive layer 120 can be disposed on the supporting platform 110 using coating process. For one example, firstly, the first adhesive portion 121 is formed on one area of the supporting surface 112 of the supporting platform 110 by applying a thinner adhesive layer. Secondly, the second adhesive portion 122 is formed on the other area of the supporting surface 112 of the supporting platform 110 by applying a thicker adhesive layer. A difference of the thickness of the first adhesive portion 121 and the second adhesive portion 122 is equal to a difference of the thickness of the first portion 210 and the second portion 220. The thicker second adhesive portion 122 connects to the thinner first adhesive portion 121. For another example, firstly a uniform adhesive layer is applied onto the supporting surface 112 of the supporting platform 110. Secondly, an additive adhesive layer is applied onto the uniform adhesive layer corresponding to the second portion 220, thereby forming the thinner first adhesive portion 121 and the thicker adhesive portion 122. A thickness of the additive adhesive layer is equal to the difference of the thickness of the first portion 210 and the second portion 220.

The adhesive layer 120 can have excellent adhesiveness and releasability by a precuring process. According to properties of different adhesive bodies 120, the methods and parameters of precuring process can be different. In the present embodiment, the adhesive layer 120 is comprised of silica. The adhesive layer 120 can be precured by a heating treatment. The solica can be precured because of prepolymerization of the silica in a thermal condition. A temperature of precuring the adhesive layer 120 is in a range from 600 to 700 Celsius degrees. A time of precuring the adhesive layer 120 is in a range from 2 to 10 minutes.

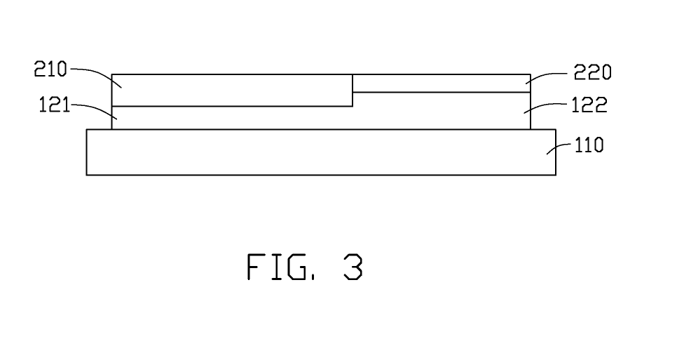

In FIG. 3, in use, the flexible printed circuit board 200 is fixed on the mounting support 100 stably. The first contacting surface 201 of the flexible printed circuit board 200 is mated with the adhering surface 129 of the adhesive layer 120. In details, the first surface 211 adheres to the second adhesive surface 124 directly, thereby mating the first adhesive portion 121 with the first portion 210. The third surface 221 adheres to the fourth adhesive surface 126 directly, thereby mating the second adhesive portion 122 with the second portion 220. Meanwhile, the side surface 213 mates with and adheres to the adhesive side surface 128 directly. As a result, the whole flexible printed circuit board 200 is stably fixed on the mounting support 100. Therefore, distortion and bend of the flexible printed circuit board 200 is avoided. Then, electronic components can be mounted on the mounting surface 202 of the flexible printed circuit board 200 retained on the mounting support 100.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A mounting support for retaining a flexible printed circuit board, the flexible printed circuit board having a first portion and a second portion, a thickness of the first portion being greater than that of the second portion, the mounting support comprising:
a supporting platform, and
an adhesive layer disposed on the supporting platform, the adhesive layer comprising a first adhesive portion for mating with the first portion of the flexible printed circuit board, and a second adhesive portion for mating with the second portion of the flexible printed circuit board, a thickness of the first adhesive portion being less than that of the second adhesive portion, a thickness difference between the first adhesive portion and the second adhesive portion being equal to a thickness difference between the first portion and the second portion.

2. The mounting support as claimed in claim 1, wherein the supporting platform is comprised of a metal material.

3. The mounting support as claimed in claim 2, wherein the metal material is selected from group consisting of copper, aluminum, iron and an alloy of copper, aluminum and iron.

4. The mounting support as claimed in claim 1, wherein the supporting platform is comprised of a polymer material.

5. The mounting support as claimed in claim 4, wherein the polymer material is polytetrafluoroethylene.

6. The mounting support as claimed in claim 1, wherein the adhesive layer is comprised of silica.

7. The mounting support as claimed in claim 6, wherein the adhesive layer is comprised of silica that is precured at a temperature in a range from 600 to 700 Celsius degrees for 2 to 10 minutes.
